(19) United States
(12) Patent Application Publication
(10) Pub. No.: US 2018/0072271 A1
(43) Pub. Date: Mar. 15, 2018

(54) METHOD FOR VEHICLE AUTO-LOCKING AND SYSTEM FOR VEHICLE AUTO-LOCKING

(71) Applicant: NIO NEXTEV LIMITED, Hong Kong (CN)

(72) Inventors: Dong YIWEI, Shanghai (CN); Liu XIAOCHEN, Shanghai (CN)

(21) Appl. No.: 15/701,786

(22) Filed: Sep. 12, 2017

(30) Foreign Application Priority Data
Sep. 14, 2016 (CN) 201610825787.4

(51) Int. Cl. B60R 25/32; E05B 77/54; B60R 25/01

(52) U.S. Cl. CPC B60R 25/32; B60R 25/01; E05B 77/54

(57) ABSTRACT

The present application relates to a method for a vehicle auto-locking. The method comprises detecting using situation of the vehicle and status of door locks; and locking the door locks in case that the using situation of the vehicle meets predetermined requirement and the door locks are unlocked. With the embodiments of the application, the drawback that a gangster may forcibly open a vehicle door to commit a robbery before the user starts the vehicle may be avoided and accordingly the user could be protected better, and a plurality of scenarios may be recognized to perform auto-locking. A system for a vehicle auto-locking is also provided.

### CROSS-REFERENCE TO RELATED APPLICATIONS

This application claims the benefit of China Patent Application No. 201610825787.4 filed Sep. 14, 2016, the entire contents of which are incorporated herein by reference.

### TECHNICAL FIELD

The present application relates to the field of vehicle technology, and more particularly, to a vehicle auto-locking method and a vehicle auto-locking system.

### BACKGROUND

After a conventional vehicle is started, it will be auto-locked only when the vehicle speed exceeds a certain value, and it requires to be manually operated by the driver if earlier locking is desired. Additionally, when there are more passengers on board, some passenger may fail to find a proper seat in time, and thus need to open the door to move to another seat, however, the vehicle has been auto-locked at this time, which would result in great inconvenience. In a word, the existing vehicle auto-locking cannot automatically lock the vehicle in a humanized manner based on the passenger's using habit or the situation of passenger load, thereby bringing great inconvenience to the vehicle owner and/or the passengers.

To this end, the present application is provided hereby.

### SUMMARY

The object of the embodiments of the application is to provide a method for a vehicle auto-locking, which addresses the technical issue about how to improve convenience of locking. A system for a vehicle auto-locking is also provided.

In order to achieve the above object, according to one aspect of the application, the following technical solutions are provided:

A vehicle auto-locking method, said method comprises: detecting using situation of the vehicle and status of vehicle door locks; and locking the vehicle door locks in case that the using situation of the vehicle meets predetermined requirement and the door locks are unlocked.

Further, the using situation of the vehicle comprises a first vehicle speed. With the using situation of the vehicle comprising a first vehicle speed, said step of locking the vehicle door locks in case that the using situation of the vehicle meets predetermined requirement and the door locks are unlocked, specifically includes locking the vehicle door locks in case that the first vehicle speed is higher than a first vehicle speed threshold and the door locks are unlocked.

Further, the using situation of the vehicle comprises a second vehicle speed, a first locking time, and status of other doors, in which said first locking time is a period from a driver entering the vehicle to the door locks being locked and said status of other doors is the status of the doors other than the driver's door. In this example, said step of locking the vehicle door locks in case that the using situation of the vehicle meets a predetermined requirement and the door locks are unlocked, specifically includes locking the door locks when said other doors are closed and not being operated as well as the second vehicle speed is above a second vehicle speed threshold during the first locking time.

Further, the using situation of the vehicle comprises a third vehicle speed, a second locking time, the number of times of vehicle travel from starting to stopping, and status of passengers, in which the second locking time is a period from a driver entering the vehicle to the door locks being locked. In the example, said step of locking the vehicle door locks in case that the using situation of the vehicle meets predetermined requirement and the door locks are unlocked, specifically includes determining an optimum locking time based on the second locking time, the number of times of vehicle travel from starting to stopping, and the number of passengers, and during the optimum locking time, locking the door locks when the third vehicle speed is higher than a third vehicle speed threshold.

Further, said step of determining an optimum locking time based on the second locking time, the number of times of vehicle travel from starting to stopping, and the number of passengers, specifically includes: before the number of times of vehicle travel from starting to stopping reaches a predetermined number, counting the number of times that the second locking time is less than a predetermined locking time as well as the number of times that the number of passengers is greater than 1, and determining the optimum locking time based on the counted number of times that the second locking time is less than the predetermined locking time as well as the counted number of times that the number of passengers is greater than 1.

According to another aspect of the present application, a system for a vehicle auto-locking is provided. The system comprises a detecting module for detecting a using situation of the vehicle and a status of vehicle door locks, and a locking module for locking the door locks in case that the using situation of the vehicle meets a predetermined requirement of the vehicle and the door locks are unlocked.

Further, the using situation of the vehicle comprises a first vehicle speed. And the locking module according to the example includes a first locking submodule for locking the door locks in case that the first vehicle speed is above the first vehicle speed threshold and the door locks are unlocked.

Further, the using situation of the vehicle comprises a second vehicle speed, a first locking time, and status of other doors, said first locking time is a period from a driver entering the vehicle to the door locks being locked, said status of other doors is the status of the doors other than the driver's door. According to the example, the locking module includes a second locking submodule for locking the door locks in case that said other doors are closed and not being operated as well as the second vehicle speed is higher than a second vehicle speed threshold during the first locking time.

Further, the using situation of the vehicle comprises a third vehicle speed, a second locking time, the number of times of vehicle travel from starting to stopping and a status of passengers, in which the second locking time is a period from a driver entering the vehicle to the door locks being locked. According to the example, the locking module specifically includes an optimum locking time determination module for determining an optimum locking time based on the second locking time, the number of times of vehicle travel from starting to stopping and the number of passengers, and a third locking submodule for locking the door locks when the third vehicle speed is higher than the third vehicle speed threshold during the optimum locking time.

Further, the optimum locking time determination module specifically includes a learning module for counting the number of times that the second locking time is less than a predetermined locking time as well as the number of times that the number of passengers is greater than 1, before the number of times of vehicle travel from starting to stopping reaches a predetermined number, and determining the optimum locking time based on the number of times that the second locking time is less than the predetermined locking time as well as the number of times that the number of passengers is greater than 1.

According to the embodiments of the application, solutions for a vehicle auto-locking are provided. In accordance with the solutions, the using situation of the vehicle and the status of door locks are detected, and the door locks are locked in case that the detected using situation of the vehicle meets a predetermined requirement as well as the door locks are unlocked, thereby achieving technical effects of recognizing multiple scenarios and thus performing auto-locking.

### BRIEF DESCRIPTION OF DRAWINGS

The accompanying drawings, as part of the application, are used for providing further understanding of the application. The illustrative embodiments of the application and the explanation thereof are used for explicating the application, but constitute no limitation to the application. In the accompanying drawings:

FIG. 1 is a flowchart of the method of a vehicle auto-locking in accordance with one exemplary embodiment of the present application; and

FIG. 2 is a block diagram of the system of a vehicle auto-locking in accordance with another exemplary embodiment of the present application.

### DESCRIPTION OF EMBODIMENTS

The technical issues addressed, the technical solutions adopted, and the technical effects achieved, by the embodiments of the application are described clearly and completely, in conjunction with the accompanying drawings and particular embodiments below. Obviously, the described embodiments are merely part of, rather than all of, the embodiments of the present application. Based on the embodiments in the present application, all other equivalents and apparent modifications of the embodiments obtained, without any creative effort of those of ordinary skills in the art, will fall within the scope of protection of the application.

It should be noted that many specific details are given in the following description in order to facilitate comprehension. Apparently, however, the implementation of the present application may be implemented without these specific details.

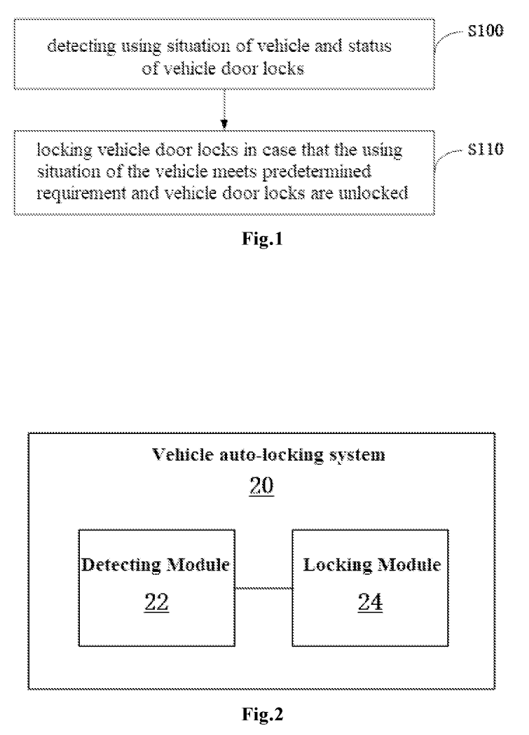

The embodiments of the present application provide a vehicle auto-locking method, in order to recognize a plurality of scenarios to perform auto-lock. As shown in FIG. 1, this method may comprise:

S100: detecting using situation of the vehicle and status of door locks.

S110: locking the door locks in case that the using situation of the vehicle meets a predetermined requirement and the door locks are unlocked.

By using the above technical solution, the user may be protected better, the drawback that a gangster may forcibly open a vehicle door to commit a robbery before the user starts the vehicle, may be avoided, and a plurality of scenarios may be recognized to perform auto-locking.

Vehicle auto-locking can be achieved by setting up a conventional vehicle speed mode, a manual mode, and an automatic learning mode according to embodiments of the present application.

For the conventional vehicle speed mode, the using situation in the above embodiments may comprise a first vehicle speed. With the using situation comprising the first vehicle speed, the step of locking the door locks in case that the using situation of the vehicle meets predetermined requirement and the door locks are unlocked, may include: locking the door locks in case that the first vehicle speed is above a first vehicle speed threshold and the door locks are unlocked.

For the manual mode, the using situation in the above embodiments may comprise a second vehicle speed, a first locking time and status of other doors, wherein the first locking time is a period from a driver entering the vehicle to the door locks being locked, the status of other doors is the status of doors other than the driver's door, thus on the basis of the above embodiments, the step of locking the door locks in case that the using situation of the vehicle meets predetermined requirement and the door locks are unlocked may include: locking the door locks in case that other doors are closed and not being operated as well as the second vehicle speed is higher than the second vehicle speed threshold during the first locking time.

For the automatic learning mode, the using situation of the vehicle in the above embodiments comprises a third vehicle speed, a second locking time, the number of times of vehicle travel from starting to stopping, and status of passengers. The second locking time is a period from a driver entering the vehicle to the door locks being locked. In the automatic learning mode, with the using situation of the vehicle meeting a predetermined requirement and the door locks unlocked, the step of locking the door locks may specifically include:

S112: determining an optimum locking time based on the second locking time, the number of times of vehicle travel from starting to stopping and the number of passengers.

S114: during the optimum locking time, locking the door locks when the third vehicle speed is higher than a third vehicle speed threshold.

In some embodiments, determining the optimum locking time based on the second locking time, the number of times of vehicle travel from starting to stopping and the number of passengers may specifically include when the number of times of vehicle travel from starting to stopping reaches a predetermined number, counting the number of times that the second locking time is less than a predetermined locking time, counting the number of times that the number of passengers is greater than 1, and performing deep learning, and constantly updating the predetermined locking time, so as to determine the optimum locking time.

The auto-locking of the automatic learning mode will be explained in detail hereinafter in combination with an embodiment.

Assume that: Tn is the period from a driver entering a vehicle (the driver's door is successfully closed after opened) to the vehicle being locked (including a user locking the doors manually), T is the default auto-locking time of the vehicle, R is the number of times that Tn<T, S is the number of times that the number of passengers is greater than 1, N is the number of times of vehicle travel from starting to stopping, b is the status of passengers, a is the operating habit of the user, V is the vehicle speed threshold, k1 and k2 represent time constants, respectively (may be adjusted based on the particular model of the vehicle and the application scenario), T_{updated} represents the updated auto-locking time, and T_{current} represents the current auto-locking time.

According to an example with N (preferably 20) being used as statistical sample, the default auto-locking time of the vehicle T under conditions of R<3, a=0; 3<=R<10, a=1; R>=10, a=2; S<3, b=0; 3<=S<10, b=1; and s>=10, b=2, respectively, is counted.

An optimum T is determined in such a way that T is constantly updated according to the following equation based on the algorithm of deep learning:

T_{updated}=T_{current}−a×k1+b×k2

Vehicle auto-locking is performed when the vehicle speed exceeds V during T.

In this embodiment, deep learning is one of the fields of machine learning research. Deep learning implements complex function approximation and input data characterization by learning a type of deep non-linear network architecture, which demonstrates a strong learning ability for essential features of data sets. As one typical deep learning method, a convolutional neural network is a multi-layer sensor. In practical applications, a convolutional neural network (CNN) may be constructed. The architecture of this convolutional neural network may comprise three convolutional layers, three down sampling layers, three non-linear propagation function layers, one full connected layer and one regression layer. The size of the convolutional kernel may be set based upon experience. Pooling layers and ReLU layers may be applied after each of the convolutional layers. All of the pooling layers employ a max pooling method, whereas the ReLUs are linear rectification functions. During training, a ReLU serves as an activation function. The full connection layer may, for example, be set to comprise 100 neurons. A regression model may be constructed to estimate the optimum auto-locking time. Certainly, those skilled in the art may understand that the architecture of the above convolutional neural network may further be set as: input layer—convolutional layer—pooling layer—convolutional layer—pooling layer—convolutional layer—convolutional layer—full connected layer—full connected layer—output layer. Wherein, the convolutional layer may use multiple convolutional kernels. The pooling layer may carry out an average pooling operation. During feature learning, in the stage of counter propagation, a gradient descent method is applied to adjust the weights and offsets of said convolutional kernels, and an up sampling operation is performed for an error of pooling layers. The size of the first 3 convolutional kernels may be set as 5×5, the size of the last 1 convolutional kernel may be set as 3×3, and the sliding step length of each layer's convolutional kernels may be set as 1. To compensate the data loss of the previous convolutional layer, when a gradient descent algorithm is used for the convolutional layers, an up sampling operation needs to be performed for the partial derivative error of pooling layers. The full connected layer connects the neurons of the current layer to the neurons of the previous layer. The output layer calculates the classification result with, for example, a softmax function. Then, the optimum auto-locking time may be derived based on the result.

It should be noted that, the above assumptions are merely exemplary, and not to be construed as an improper limitation to the scope of protection of the application.

In the above embodiments, although the steps are described by way of the above precedence order, it may be understood by those skilled in the art that, in order to achieve the effects of this embodiment, different steps are not necessarily to be executed in accordance with such an order, instead, they may be executed simultaneously (in parallel) or in a reverse order or in other orders. All of these simple changes fall within the scope of protection of the application.

Based upon the technical conception same as the embodiments of the method, a system for a vehicle auto-locking system as shown in FIG. 2 is provided herein. As shown in FIG. 2, the system comprises a detecting module 22 and a locking module 24. The detecting module 22 is used for detecting the using situation of the vehicle and the status of the door locks. The locking module 24 is used for locking the door locks in case that the using situation of the vehicle meets a predetermined requirement and the door locks are unlocked.

In some embodiments, said using situation of the vehicle comprises a first vehicle speed. Specifically, the locking module may include a first locking submodule used for locking the door locks in case that the first vehicle speed is higher than the first vehicle speed threshold and the door locks are unlocked.

In some other embodiments, the using situation of the vehicle comprises a second vehicle speed, a first locking time and status of other doors. According to those embodiments, the first locking time is a period from a driver entering a vehicle to the door locks being locked, the status of other doors is the status of doors other than the driver's door; the locking module may specifically include a second locking submodule used for locking the door locks in case that other doors are closed and not being operated as well as the second vehicle speed is higher than a second vehicle speed threshold during the first locking time.

In some embodiments, the using situation of the vehicle comprises a third vehicle speed, a second locking time, the number of times of vehicle travel from starting to stopping and status of passengers. According to the embodiments, the second locking time is a period from a driver entering a vehicle to the door locks being locked, and the locking module may specifically include an optimum locking time determination module and a third locking submodule. The optimum locking time determination module is used for determining the optimum locking time based on the second locking time, the number of times of vehicle travel from starting to stopping and the number of passengers. The third locking submodule is used for locking the door locks when the third vehicle speed is higher than the third vehicle speed threshold during the optimum locking time.

In embodiments as above mentioned, the optimum locking time determination module may further include a learning module, wherein the learning module is used for counting the number of times that the second locking time is less than a predetermined locking time as well as the number of times that the number of passengers is greater than 1, performing deep learning, and constantly updating the predetermined locking time, so as to determine the optimum locking time.

It should be noted that, when the vehicle auto-locking system provided by the above embodiments performs auto-locking, the division of each function module mentioned above is merely used as an illustrative example, in practical applications, the above function assignment may be accomplished by various function modules as needed, i.e., the modules or the steps in the embodiments of the application are further split or combined. For example, the modules of the above embodiments may be combined into a single module, or may be further split into a plurality of submodules, in order to accomplish all or part of the functions described above. The name of the modules and steps related in the embodiments of the application are merely used for distinguishing various modules or steps, and should not to be construed as an improper limitation to the present application.

It may be understood by those skilled in the art that the above vehicle auto-locking system may further include some other well-known structures, such as processers, controllers, and memories, etc., wherein, the memories include but not limited to, random access memories, flashes, read only memories, programmable read only memories, transitory memories, non-transitory memories, serial memories, parallel memories, or registers, etc., the processers include but not limited to, CPLD/FPGAs, DSPs, ARM processors, MIPS processers, etc. These well-known structures are not shown in FIG. 2 in order to avoid unnecessarily obscuring the embodiments of the application.

It should be understood that the number of each module in FIG. 2 is merely illustrative. Each module may be of arbitrary amount according to actual needs.

The above embodiments of the system may be used for implementing the above embodiments of the method, the technical principle, the addressed technical issue, and the resulting technical effects of which are similar to those of the method. It may be clearly realized by one of ordinary skill in the art that, for convenience and clarity, the specific operating process and the related illustration of the system described above may refer to the respective process in the foregoing embodiments of the method, and will not to be repeated herein.

It should be noted further that the terms ‘first’, ‘second’, etc. in the specification and claims of the application as well as the accompanying drawings are used for distinguishing similar objects, rather than for describing or representing a specific order or a sequential order. It should be understood that the data used this way may be swapped under appropriate circumstances, so that the embodiments of the application described herein may be implemented in an order other than those illustrated or described herein.

The term ‘comprise’ or any other similar phraseologies intend to encompass nonexclusive inclusions, so as to render the processes, methods, items, or devices/apparatuses including a series of factors to not only comprise those factors, but also comprise other factors that are not explicitly cited, or also comprise the inherent factors of these processes, methods, items, or devices/apparatuses.

As used herein, the term ‘module’ may indicate a software object or a routine executed on a computer system. Various modules described herein may be implemented as an object or a process (e.g., as an independent thread) executed on a computer system. Although the system and method described herein are implemented preferably with software, it is also possible and may be thought of to implement with hardware or a combination of software and hardware.

It should further be noted that, the language used in the specification is mainly chosen for the purpose of readability and teaching, rather than chosen for explaining or limiting the subject of the application.

The present application is not limited to the embodiments above, any modification, improvement or alternation that one of ordinary skill in the art may come up with will fall within the scope of protection of the application, without departing from the substantial content of the application.

What is claimed is:

1. A method for a vehicle auto-locking, comprising:
detecting using situation of the vehicle and status of vehicle door locks; and
locking the vehicle door locks in case that the using situation of the vehicle meets a predetermined requirement and the door locks are unlocked.

2. The method of claim 1, wherein the using situation of the vehicle comprises a first vehicle speed; and
said step of locking the vehicle door locks in case that the using situation of the vehicle meets a predetermined requirement and the door locks are unlocked, specifically includes:
locking the vehicle door locks in case that the first vehicle speed is higher than a first vehicle speed threshold and the door locks are unlocked.

3. The method of claim 1, wherein the using situation of the vehicle comprises a second vehicle speed, a first locking time and status of other doors, said first locking time is a period from a driver entering the vehicle to the door locks being locked, said status of other doors is the status of the doors other than the driver's door; and
said step of locking the vehicle door locks in case that the using situation of the vehicle meets a predetermined requirement and the door locks are unlocked, specifically includes:
locking the door locks when said other doors are closed and not being operated as well as the second vehicle speed, during the first locking time, is above a second vehicle speed threshold.

4. The method of claim 1, wherein the using situation of the vehicle comprises a third vehicle speed, a second locking time, the number of times of vehicle travel from starting to stopping, and status of passengers; wherein, the second locking time is a period from a driver entering the vehicle to the door locks being locked; and
said step of locking the vehicle door locks in case that the using situation of the vehicle meets a predetermined requirement and the door locks are unlocked, specifically includes:
determining an optimum locking time based on the second locking time, the number of times of vehicle travel from starting to stopping, and the number of passengers; and
during the optimum locking time, locking the door locks when the third vehicle speed is above a third vehicle speed threshold.

5. The method of claim 4, wherein said step of determining an optimum locking time based on the second locking time, the number of times of vehicle travel form starting to stopping, and the number of passengers, specifically includes:
before the number of times of vehicle travel from starting to stopping reaches a predetermined number of times of vehicle travel from starting to stopping, counting the number of times that the second locking time is less than a predetermined locking time as well as the number of times that the number of passengers is greater than 1, and determining the optimum locking time based on the counted number of times that the second locking time is less than the predetermined locking time as well as the counted number of times that the number of passengers is greater than 1.

6. A system for a vehicle auto-locking, comprising:
a detecting module for detecting using situation of the vehicle and status of vehicle door locks; and
a locking module for locking the door locks in case that the using situation of the vehicle meets a predetermined requirement of the vehicle and the door locks are unlocked.

7. The system of claim 6, wherein the using situation of the vehicle comprises a first vehicle speed; and
the locking module includes:
a first locking submodule for locking the door locks in case that the first vehicle speed is above the first vehicle speed threshold and the door locks are unlocked.

8. The system of claim 6, wherein the using situation of the vehicle comprises a second vehicle speed, a first locking time, and status of other doors, said first locking time is a period from a driver entering the vehicle to the door locks being locked, said status of other doors is the status of the doors other than the driver's door; and
the locking module includes:
a second locking submodule for locking the door locks in case that said other doors are closed and not being operated as well as the second vehicle speed is above a second vehicle speed threshold during the first locking time.

9. The system of claim 6, wherein the using situation of the vehicle comprises a third vehicle speed, a second locking time, the number of times of vehicle travel from starting to stopping and status of passengers; wherein, the second locking time is a period from a driver entering the vehicle to the door locks being locked; and
the locking module includes:
an optimum locking time determination module for determining an optimum locking time based on the second locking time, the number of times of vehicle travel from starting to stopping and the number of passengers; and
a third locking submodule for locking the door locks when the third vehicle speed is above the third vehicle speed threshold during the optimum locking time.

10. The system of claim 9, wherein the optimum locking time determination module includes:
a learning module for counting the number of times that the second locking time is less than a predetermined locking time as well as the number of times that the number of passengers is greater than 1, before the number of times of vehicle travel from starting to stopping reaches a predetermined number, and for determining the optimum locking time based on the counted number of times that the second locking time is less than the predetermined locking time as well as the counted number of times that the number of passengers is greater than 1.
